(19) United States
(12) Patent Application Publication
(10) Pub. No.: US 2026/0295431 A1
(43) Pub. Date: Oct. 1, 2026

(54) LARGE LANGUAGE MODEL-DRIVEN WORLD ADAPTATION FOR EMERGENT GAMEPLAY

(71) Applicant: PostVoyage LLC, Neward, DE (US)

(72) Inventor: John Bowie, Palo Alto, CA (US)

(21) Appl. No.: 19/553,190

(22) Filed: Feb. 27, 2026

Related U.S. Application Data
(60) Provisional application No. 63/780,962, filed on Mar. 31, 2025.

(51) Int. Cl. A63F 13/67; A63F 13/55; A63F 13/822; G06N 7/01

(52) U.S. Cl. CPC A63F 13/67; A63F 13/55; A63F 13/822; G06N 7/01

(57) ABSTRACT

Systems and methods related to large language model-driven world adaptation for emergent gameplay are disclosed herein. For example, a computer-implemented method for controlling gameplay in an interactive computer game may comprise maintaining non-player character (NPC) states and a world state. Each NPC state may include an alignment vector and data representative of prior in-game interactions with the corresponding NPC. The world state may govern relationships among NPCs. The method may further comprise generating, by a large language model, a control output based on probabilistic reasoning, the world state, and an NPC state. The method may further comprise modifying the world state based on the control output. Gameplay is improved by enabling NPCs and game worlds to evolve dynamically based on probabilistic reasoning over prior interactions and alignment states, resulting in more immersive, emergent, and player-responsive experiences without reliance on pre-scripted behavior.

### CROSS REFERENCE TO RELATED APPLICATIONS

This application claims the benefit of U.S. Provisional Patent Application No. 63/780,962, filed Mar. 31, 2025, which is incorporated by reference herein in its entirety for all purposes.

### BACKGROUND

The present description relates to using a large language model (LLM) to improve gameplay in computer-implemented games. Video games and other interactive digital environments commonly include non-player characters (NPCs) that are designed to interact with players, advance narrative elements, or simulate autonomous entities within a virtual world. In conventional game architectures, NPC behavior is typically implemented using pre-scripted logic, deterministic decision trees, finite state machines, or manually authored behavior rules. Similarly, other core gameplay elements, such as quest structures, player objectives, and in-game item generation, are often defined using static scripts, fixed templates, or predefined tables. While such approaches allow developers to control gameplay outcomes and ensure predictable system behavior, they often result in repetitive or foreseeable NPC actions, quests, and items, particularly after extended gameplay, thereby limiting immersion and reducing the capacity for emergent storytelling.

To introduce variability, some systems employ probabilistic models, rule-based randomness, or behavior trees augmented with weighted decision paths. However, these techniques generally require extensive manual tuning and foreknowledge of possible gameplay scenarios. As a result, NPC responses are constrained to a predefined design space and cannot readily adapt to unanticipated player behavior, evolving game conditions, or complex interactions among multiple NPCs or factions. Once deployed, such systems typically do not exhibit meaningful long-term evolution without explicit developer intervention.

Recent advancements in artificial intelligence (AI), including natural language processing and machine learning techniques, have demonstrated the ability to model complex patterns, generate contextually relevant outputs, and respond dynamically to input data. In particular, LLMs have shown an ability to reason probabilistically over diverse inputs and generate coherent responses across a wide range of contexts. While such models have been explored for dialogue generation or narrative content creation, their integration into gameplay systems has generally been limited to surface-level interactions and does not extend to controlling underlying game mechanics or long-term world evolution.

Existing approaches to NPC adaptation therefore continue to rely on static or semi-static control logic, such as scripted events, manually designed probability distributions, behavior trees, or narrowly scoped machine learning components. These approaches lack mechanisms for dynamically evolving gameplay based on player interactions, in-game events, or emergent faction dynamics. The approaches also lack the ability to maintain persistent NPC state across interactions, dynamically modify relationships among NPCs based on emergent conditions, and coordinate higher-level world dynamics such as faction relationships, alliances, or conflicts. Consequently, gameplay systems remain largely reactive rather than adaptive, and player actions often have limited long-term impact on the behavior of the game world. Accordingly, there exists a need for gameplay control systems that enable NPCs and virtual worlds to evolve dynamically during runtime, respond meaningfully to player interactions and in-game events, and maintain continuity across gameplay sessions.

### SUMMARY

This disclosure relates to world adaption for emergent gameplay driven by at least one large language model (LLM). Using at least one LLM, the world of the game may adapt; for example, the system may adapt non-player character (NPC) behavior, NPC relationships, item generation, quests, rewards, and difficulty level. The at least one LLM may also provide dynamic storytelling, complex emotionality, empath, worldbuilding, mythology, etc. The systems and methods described herein use AI techniques to perform real-time, context-aware reasoning over game state and historical interaction data, thereby supporting more immersive, adaptive, and emergent gameplay experiences. The present invention provides systems and methods for controlling gameplay in an interactive computer game by dynamically modifying NPC behavior and world-level relationships using an LLM. In contrast to conventional scripted or rule-based approaches, the disclosed systems enable runtime, probabilistic reasoning over game state to support adaptive, emergent, and persistent gameplay experiences. The system may dynamically adjust NPC behavior through a neural memory structure that evolves based on player interactions, probabilistic reasoning, and emergent in-game patterns.

In specific embodiments, a computing system executing a game engine may maintain a plurality of NPC states corresponding to a plurality of NPCs, one or more item states corresponding to a plurality of in-game items, as well as a world state that governs relationships among the NPCs and/or interactions involving the in-game items. Each NPC state may include data representative of prior in-game interactions and an alignment vector encoding tendencies, affiliations, or dispositions of the corresponding NPC. Similarly, each item state may include data representative of prior in-game usage, acquisition history, ownership, contextual associations, or attribute modifications applicable to the corresponding item. For example, a starting sword may acquire a history and traits as the player explores the world. The world state may aggregate information derived from multiple NPC states and item states and may govern interaction rules, relationships, or constraints applicable to individual NPCs, groups of NPCs, individual items, and/or groups of items. NPCs may adapt their roles, allegiances, motives, aversions, phobias, passions, or relative standing within groups or factions using a hierarchical reinforcement learning framework. In specific embodiments, item states may likewise be modified based on gameplay events, such that item attributes, availability, or contextual behavior evolve in response to changes in world state. Under this framework, lower-level decision processes may govern immediate NPC actions or item behavior and attribute selection, while higher-level decision processes may evaluate longer-term outcomes reflected in changes to the world state and accumulated gameplay history. Based on emergent gameplay dynamics, such as shifts in faction relationships, outcomes of prior interactions, or changes in alignment vectors, NPCs may independently modify their affiliation, rank, or strategic role within a faction. Similarly, items may be modified (or new items may be generated) in attributes, rarity, accessibility, or associated narrative context based on aggregated gameplay outcomes and probabilistic reasoning. These modifications are not predefined by scripted events but arise from learning signals derived from gameplay outcomes and evaluated in conjunction with the LLM's probabilistic reasoning. As a result, NPCs can exhibit long-term behavioral evolution, including leadership changes, defections, or realignments, and items can exhibit evolving attributes, availability conditions, or contextual roles, that reflect accumulated gameplay context rather than static design-time rules.

In specific embodiments, NPC behavior may be dynamically adapted using an LLM that evaluates both current gameplay conditions and persistent NPC state information. A game engine or computing system may maintain a neural memory structure associated with each NPC that stores data representative of prior in-game interactions for the corresponding NPC, along with a character alignment vector encoding tendencies, affiliations, or dispositions of the NPC. The computing system may maintain one or more neural memory structures that store information associated with a plurality of NPCs. The information associated with each NPC may be stored in separate memory structures, separate logical partitions of a shared memory structure, or a combination thereof. During runtime execution of the game engine, the LLM may retrieve and evaluate this neural memory information and may use probabilistic reasoning to generate control outputs that influence NPC behavior. As a result, NPCs may alter dialogue behavior, strategic decisions, affiliations, or interaction patterns in a manner that reflects accumulated experience rather than predefined scripts. This LLM-driven adaptation enables NPC behavior to evolve over time, allowing NPC responses to remain contextually consistent with past interactions while dynamically adjusting to new gameplay events.

During gameplay execution, an LLM may be executed to evaluate at least one NPC state and the world state and to generate one or more control outputs using probabilistic reasoning. The control outputs may be applied by the game engine to modify the world state, thereby influencing relationships among NPCs, such as alliances, hostilities, roles, or faction dynamics. Through this process, NPC behavior and world-level conditions may evolve dynamically based on gameplay context rather than predetermined scripts. Based on probabilistic reasoning performed by the LLM and changes to alignment vectors associated with individual NPCs, factions may adaptively engage in diplomatic actions such as forming alliances, maintaining cooperation, renegotiating relationships, or initiating betrayals. These faction-level decisions are not predefined by static rules but emerge from ongoing evaluation of relative benefits, risks, and anticipated future states of the game world. As a result, faction behavior evolves dynamically in response to player actions and in-game events, enabling shifting power structures and emergent strategic interactions that persist across gameplay executions.

In specific embodiments, the NPC states and alignment vectors may be updated over time based on prior gameplay events and may be stored in persistent memory, enabling NPC behavior and world dynamics to persist across gameplay sessions or game instances. Such persistence allows changes resulting from gameplay by one player to influence NPC behavior experienced by other players, thereby supporting shared, evolving virtual worlds. NPC evolution may persist across multiple game instances by storing NPC state information in persistent memory accessible to the computing system. The stored NPC states may include attributes that influence future behavior. When a new game instance is initiated, whether for the same player or a different player within a shared multiplayer ecosystem, the game engine may retrieve the stored NPC states and incorporate them into the current gameplay execution. As a result, changes to NPC behavior, relationships, or affiliations that occur in one gameplay instance may influence subsequent interactions in other gameplay instances. This persistent cross-instance NPC evolution enables continuity and shared world progression without requiring centralized scripting, allowing NPCs to reflect accumulated experiences and emergent dynamics across a distributed set of player sessions.

In specific embodiments, modifying the world state may include generating or updating quest structures, objectives, or gameplay events based on the current world state and the control outputs generated by the LLM. In specific embodiments, gameplay parameters governing reward allocation or difficulty levels may be adjusted indirectly through changes to the world state, enabling adaptive balancing that reflects evolving NPC relationships and world conditions. The system may dynamically generate and update quest structures during gameplay execution based on real-time player actions and changes to the world state. Rather than relying on pre-authored quest scripts or fixed branching logic, the game engine may evaluate current gameplay conditions, including player interactions, NPC alignment vectors, and faction-level relationships, and may apply control outputs generated by the LLM to determine quest objectives, constraints, or outcomes. Quest structures may evolve over time in response to changes in the world state, such that completion or failure of a quest influences subsequent quests or world-level conditions. This dynamic quest generation enables gameplay experiences to diverge organically based on player behavior and emergent interactions, supporting variability and continuity without requiring explicit designer-defined quest sequences.

By integrating an LLM as a runtime decision authority within the game engine, the disclosed methods and systems provide a unified framework for NPC evolution, world-state governance, and adaptive gameplay control. This approach enables richer immersion, emergent storytelling, and strategic variability while reducing reliance on manually authored scripts or static behavioral models. For example, systems and methods disclosed herein improve player immersion by creating NPCs with evolving personalities, memory retention, and decision-making capabilities that react meaningfully to gameplay context.

In specific embodiments of the invention, a computer-implemented method for controlling gameplay in an interactive computer game is provided. The method comprises maintaining, by a computing system executing a game engine, a plurality of NPC states for a plurality of NPCs and a world state. Each NPC state of the plurality of NPC states: (i) corresponds to an NPC of the plurality of NPCs, (ii) includes data representative of prior in-game interactions with the corresponding NPC, and (iii) includes an alignment vector of the corresponding NPC. The world state governs relationships among the plurality of NPCs based at least in part on the alignment vectors of the plurality of NPCs. The method also comprises generating, by an LLM, one or more control outputs based on probabilistic reasoning, the world state, and at least one NPC state of the plurality of NPC states; and modifying, by the game engine, the world state based on the one or more control outputs.

In specific embodiments of the invention, a system for controlling gameplay in an interactive computer game is provided. The system comprises a computing system including one or more processors and memory; and a game engine executed by the one or more processors. The game engine is configured to maintain a plurality of NPC states for a plurality of NPCs and a world state. Each NPC state of the plurality of NPC states: (i) corresponds to an NPC of the plurality of NPCs, (ii) includes data representative of prior in-game interactions with the corresponding NPC, and (iii) includes an alignment vector of the corresponding NPC. The world state governs relationships among the plurality of NPCs based at least in part on the alignment vectors of the plurality of NPCs. The system also comprises an LLM executed by the one or more processors and configured to generate one or more control outputs based on probabilistic reasoning, the world state, and at least one NPC state of the plurality of NPC states. The game engine is further configured to modify the world state based on the one or more control outputs generated by the LLM.

In specific embodiments of the invention, a non-transitory computer-readable medium storing instructions that, when executed by one or more processors, cause the one or more processors to perform operations for controlling gameplay in an interactive computer game is provided. The operations comprise maintaining, by a computing system executing a game engine, a plurality of NPC states for a plurality of NPCs and a world state. Each NPC state of the plurality of NPC states: (i) corresponds to an NPC of the plurality of NPCs, (ii) includes data representative of prior in-game interactions with the corresponding NPC, and (iii) includes an alignment vector of the corresponding NPC. The world state governs relationships among the plurality of NPCs based at least in part on the alignment vectors of the plurality of NPCs. The operations also comprise generating, by an LLM, one or more control outputs based on probabilistic reasoning, the world state, and at least one NPC state of the plurality of NPC states; and modifying, by the game engine, the world state based on the one or more control outputs.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of an overview of the LLM-driven NPC adaptation system architecture in accordance with specific embodiments of the inventions disclosed herein.

FIG. 2 provides an example of a flowchart showing how NPCs adapt in real time based on game events in accordance with specific embodiments of the inventions disclosed herein.

FIG. 3 provides an example of evolution of in-game factions based on LLM-driven game theory modeling in accordance with specific embodiments of the inventions disclosed herein.

FIG. 4 provides an example of how NPCs persist across multiple game instances using an LLM-driven neural game state repository in accordance with specific embodiments of the inventions disclosed herein.

FIG. 5 provides an example of an LLM-driven quest generation system in accordance with specific embodiments of the inventions disclosed herein.

FIG. 6 provides an example of how player performance, engagement, and strategic depth are analyzed to dynamically adjust rewards in accordance with specific embodiments of the inventions disclosed herein.

FIG. 7 provides an example of a system for controlling gameplay in an interactive computer game in accordance with specific embodiments of the inventions disclosed herein.

FIG. 8 provides an example of gameplay control architecture of a lore machine in accordance with specific embodiments of the inventions disclosed herein.

FIG. 9 provides an example of a method for controlling gameplay in an interactive computer game in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for large language model-driven world adaptation for emergent gameplay in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

The present invention relates to computer-implemented methods and systems for controlling gameplay in interactive computer games and, more particularly, to methods and systems in which gameplay behavior and world-level relationships are dynamically modified during runtime execution of a game engine. The systems and methods utilize neural memory structures to store NPC personality traits, hierarchical reinforcement learning model for role modifications, and an evolutionary game theory framework to manage faction interactions. NPC states persist across multiple game sessions. Dynamically generated quest structures ensure unique playthroughs. The approaches described herein enhance immersion by creating NPCs that evolve meaningfully based on player actions and emergent gameplay patterns.

In specific embodiments, a computing system executes a game engine that maintains structured data representations of non-player character (NPC) states and a world state, and applies outputs generated by a large language model (LLM) to modify those data representations. Unlike conventional systems that rely on pre-scripted logic, deterministic decision trees, or static probability tables, the disclosed systems operate by evaluating current game-state data and previously stored interaction data to effect changes to gameplay mechanics in real time.

In specific embodiments, each NPC may be associated with an NPC state maintained by the game engine, where the NPC state may include data representative of prior in-game interactions and an alignment vector encoding tendencies, affiliations, or dispositions of the NPC. In addition, the game engine may maintain a world state that governs relationships among multiple NPCs based, at least in part, on the alignment vectors of the NPCs. These NPC states and world states may be stored as machine-readable data structures in system memory and may be updated programmatically during gameplay execution. By maintaining and modifying these data structures, the system enables coordinated, multi-entity gameplay changes that extend beyond individual NPC responses.

During runtime execution of the game engine, an LLM may be executed by the computing system to evaluate at least a portion of an NPC state and at least a portion of the world state and to generate one or more control outputs using probabilistic reasoning. The control outputs are not limited to generating narrative text or dialogue, but instead specify modifications to the world state that directly influence gameplay behavior, such as changes to relationships among NPCs, faction dynamics, quest structures, or gameplay parameters. The game engine may apply the control outputs to update the world state, thereby affecting how NPCs behave in subsequent gameplay interactions. In this manner, the LLM operates as a runtime decision component integrated within the game engine, rather than as a standalone content-generation tool.

In specific embodiments, the disclosed methods and systems may operate as runtime gameplay orchestration mechanisms that adapt encounters, narrative progression, and gameplay structure based on accumulated player interactions and maintained game state. Rather than relying on predefined branching scripts or static narrative paths, the system may evaluate player performance, prior decisions, and engagement patterns using LLM-based probabilistic reasoning to determine appropriate modifications to gameplay behavior. Through this evaluation, the system may approximate (or predict) a player's current (or future) gameplay context—including inferred strategic tendencies, engagement level, responsiveness to prior events, or emotional state—and generate control outputs that influence which encounters, events, characters, or behavioral patterns are activated during runtime. In this manner, the LLM may act as a “sentient storyteller” at a runtime level that augments vast aspects of gameplay beyond isolated NPC realism. In specific embodiments, the system may (via NPCs, items, narration, music, lighting, or other mean) respond to a player's inferred emotional state. The emotional state may be inferred based on observable gameplay data. For example, a character running in circles may indicate frustration or boredom. The system may respond by narrating a hint to a current puzzle (frustration) or spawning an enemy (boredom).

By structuring gameplay control around maintained state data, probabilistic model execution, and programmatic state modification, the disclosed systems and methods provide a technical mechanism for enabling adaptive and emergent gameplay behavior that evolves over time. The described approaches improve upon prior systems by allowing gameplay outcomes to be determined based on accumulated interaction data and current world conditions, while remaining grounded in concrete computing operations such as state maintenance, model execution, and memory updates. As a result, the invention enables persistent, context-aware gameplay evolution across gameplay sessions and game instances without reliance on static scripts or manual intervention.

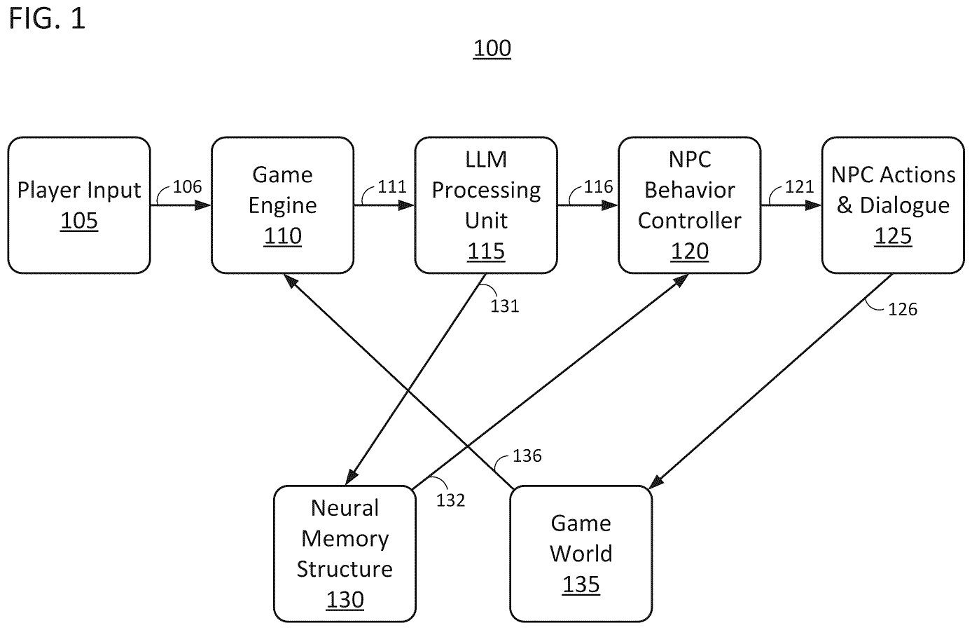

FIG. 1 illustrates an example system architecture 100 for controlling gameplay in an interactive computer game using an LLM in accordance with specific embodiments of the inventions disclosed herein. As shown, the system includes player input 105, game engine 110, LLM processing unit 115, NPC behavior controller 120, NPC actions and dialogue 125, neural memory structure 130, and game world 135. The components may be implemented by one or more computing systems including one or more processors and memory, and may cooperate to dynamically modify NPC behavior and world-level relationships during runtime execution of the game engine. Player input, game state data, and NPC memory structures may interact with the LLM processing unit. The LLM may dynamically adjust NPC behavior, dialogue, and decision-making in response to evolving gameplay conditions.

Player input 105 may represent user actions received during gameplay, such as control inputs, dialogue selections, or other interactions. Player input 105, in the form of player action data 106, may be provided to game engine 110, which may maintain game-state data structures including a plurality of NPC states and a world state. Each NPC state may correspond to an NPC and may include data representative of prior in-game interactions with the corresponding NPC, as well as an alignment vector encoding tendencies, affiliations, or dispositions of the NPC. The world state, represented by game world 135, may govern relationships among multiple NPCs based at least in part on the alignment vectors of the NPCs.

During gameplay execution, game engine 110 may provide relevant game-state and world state data 111 to LLM processing unit 115. LLM processing unit 115 may execute an LLM configured to perform probabilistic reasoning over the world state and at least one NPC state. In specific embodiments, LLM processing unit 115 may retrieve information from neural memory structure 130, which may store persistent data associated with NPCs, including historical interaction data and alignment vectors. Neural memory structure 130 may comprise one or more memory structures that retain information across multiple interactions, gameplay sessions, or game instances.

LLM processing unit 115 may output memory update data 131 to neural memory structure 130. Memory update data 131 may represent machine-readable information generated by the LLM during probabilistic reasoning over NPC state and world state, including updates to alignment vectors, representations of recent interactions, inferred tendencies, or other state attributes associated with one or more NPCs. The neural memory structure 130 may store memory update data 131 as part of persistent NPC state information, enabling accumulation of interaction history and behavioral context over time. In specific embodiments, memory update data 131 may modify existing alignment vectors or add new entries to the neural memory structure, thereby influencing future gameplay decisions generated by the LLM. By writing memory update data 131 to neural memory structure 130, the system enables long-term NPC evolution based on prior gameplay events rather than transient runtime conditions.

Neural memory structure 130 may provide NPC state data 132 to NPC behavior controller 120. NPC state data 132 may include machine-readable information associated with one or more NPCs, such as data representative of prior in-game interactions, stored alignment vectors, and other persistent attributes accumulated over time. NPC behavior controller 120 may retrieve NPC state data 132 and use the data to inform application of control outputs 116 generated by the LLM, including determining how NPC behaviors, relationships, or roles are modified in view of historical context. By supplying NPC state data 132 from neural memory structure 130 to NPC behavior controller 120, the system may ensure that NPC behavior is influenced by persistent state information rather than solely by transient runtime conditions. This retrieval mechanism may enable continuity of NPC behavior across gameplay interactions, gameplay sessions, or gameplay instances, including scenarios in which gameplay by one player influences subsequent behavior of NPCs encountered by another player.

Based on the evaluated NPC state, world state, and information retrieved from neural memory structure 130, LLM processing unit 115 may generate one or more control outputs 116. These control outputs 116 may be provided to NPC behavior controller 120, which may apply them to modify gameplay behavior. In particular, NPC behavior controller 120 may modify the world state maintained by game engine 110, including altering relationship parameters governing interactions among NPCs, updating alignment vectors, or otherwise adjusting faction-level or group-level relationships represented in game world 135.

The modified world state may influence subsequent NPC actions and dialogue 125 via NPC behavior commands 121. NPC actions and dialogue 125 may represent observable NPC behavior presented during gameplay, including dialogue responses, strategic actions, affiliations, interaction patterns, movement, combat actions, cooperation, hostility, or other interactions with players or other NPCs. These behaviors may produce gameplay interaction events that may be processed by the game engine to update the world state maintained in the game world 135; NPC actions and dialogue 125 may generate gameplay interaction events 126 that are applied to game world 135. In particular, the gameplay interaction events may cause modifications to relationship parameters, faction affiliations, territorial control, or other world-level data that governs interactions among a plurality of NPCs. By propagating NPC actions and dialogue as gameplay interaction events to game world 135, the system enables changes in individual NPC behavior to have persistent, system-level effects on the world state, thereby influencing subsequent NPC behavior and gameplay outcomes. In this manner, NPC behavior is dynamically adapted based on probabilistic reasoning performed by LLM processing unit 115 rather than predefined scripts or deterministic rules.

Game world 135 may provide updated world state data 136 to the game engine 110 following application of gameplay interaction events. Updated world state data 136 may represent one or more machine-readable data structures reflecting current world-level conditions, including modified relationship parameters, faction affiliations, alignment-based interactions, or other aggregated state derived from actions of one or more NPCs. Game engine 110 may receive updated world state data 136 and may incorporate it into subsequent gameplay execution, including maintaining the plurality of NPC states and governing future interactions among NPCs. By feeding the updated world state data back into game engine 110, the system closes a control loop in which modifications to the world state persist beyond individual NPC actions and influence later decision-making by the LLM and the NPC behavior controller. This feedback mechanism enables continued world evolution over time and supports persistent gameplay effects across interactions, gameplay sessions, or game instances.

Updates to the NPC states and world state may be stored in neural memory structure 130 for use in subsequent gameplay executions, thereby enabling persistent NPC evolution and continuity across gameplay sessions or between different players. As illustrated in FIG. 1, the LLM operates as a runtime decision authority integrated with game engine 110, generating control outputs that directly influence modifications to the world state rather than merely producing narrative text. This architecture enables coordinated, multi-NPC behavior adaptation and world-level gameplay evolution grounded in maintained state data, model execution, and programmatic state modification.

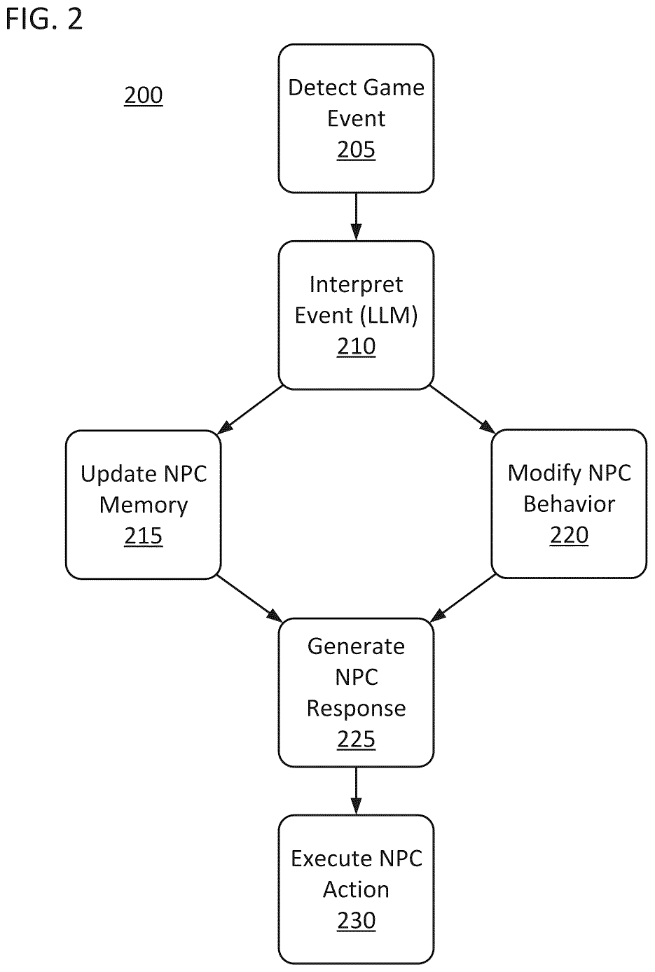

FIG. 2 illustrates an example flowchart 200 of an NPC behavior modification process in accordance with specific embodiments of the inventions disclosed herein. Flowchart 200 depicts how NPCs may dynamically adapt behavior in response to detected game events using an LLM, persistent NPC memory, and world-state-driven reasoning. NPCs may adapt in real time based on game events. The process shown in FIG. 2 may be performed during runtime execution of a game engine and may be repeated continuously as gameplay progresses. Flowchart 200 includes detecting in-game events, LLM-driven event interpretation, NPC memory updates, and dynamic behavior modification, leading to context-aware NPC responses. Flowchart 200 may employ a reinforcement learning model that allows NPCs to self-modify their roles and faction standings. Instead of following pre-programmed behavior trees, NPCs may adjust their actions based on game-state changes, emerging as faction leaders, forming alliances, or betraying their previous affiliations based on LLM-driven probabilistic reasoning.

At step 205, a game event may be detected. The detected game event may correspond to a player action, an interaction between NPCs, a change in world state, or another gameplay condition affecting one or more NPCs. The detected game event may be provided to event interpretation step 210, where the event may be interpreted by an LLM. During this stage, the LLM may evaluate the detected event in view of current NPC state, world state, and previously stored interaction data, and may perform probabilistic reasoning to determine the significance of the event relative to ongoing gameplay dynamics.

The LLM-driven interpretation may trigger multiple events. NPC memory may be updated at step 215. Updating NPC memory may include modifying data representative of prior in-game interactions, updating alignment vectors, or storing inferred tendencies or preferences associated with the NPC in a neural memory structure. This update may enable accumulation of historical context that influences future NPC behavior. NPC behavior may be modified at step 220, which may include adjusting behavior parameters, role assignments, faction affiliations, or decision-making tendencies of the NPC based on the interpreted event and the current world state.

Following the memory update and behavior modification steps, an NPC response may be generated at step 225. The NPC response may represent a context-aware output determined based on the updated NPC memory and modified behavior parameters. The NPC response may include selection of an action, dialogue output, strategic decision, or other gameplay-relevant behavior. The generated NPC response may then be executed at step 230, resulting in observable NPC actions within the game world, such as dialogue delivery, movement, cooperation, hostility, or interaction with other NPCs or player characters.

In specific embodiments, the process illustrated in FIG. 2 may implement a hierarchical reinforcement learning framework. Lower-level decision processes may govern immediate NPC actions, while higher-level processes may update alignment vectors, roles, or faction standings based on long-term gameplay outcomes reflected in NPC memory and world state. Rather than following static behavior trees or pre-scripted logic, NPCs may evolve dynamically in response to accumulated experience, enabling emergent behavior such as leadership changes, alliance formation, or betrayal. NPCs may similarly evolve different personal traits such as motives, aversions, phobias, passions, etc. The repeated execution of the flowchart shown in FIG. 2 enables continuous NPC adaptation grounded in maintained state data, LLM-based probabilistic reasoning, and programmatic state updates.

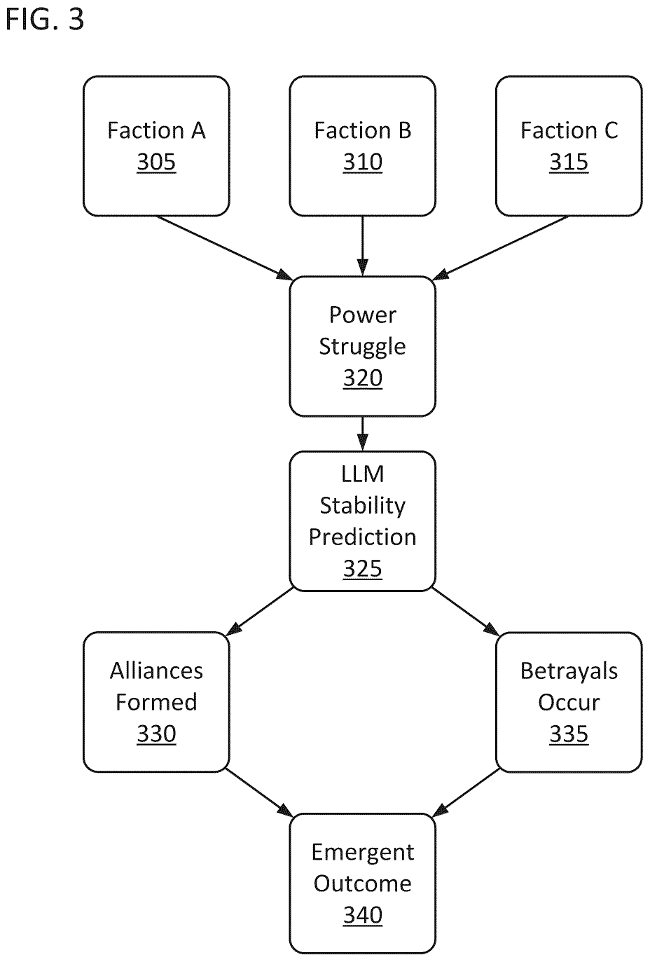

FIG. 3 illustrates an example of faction evolution governed by LLM-driven game-theoretic modeling within an interactive computer game in accordance with specific embodiments of the inventions disclosed herein. The figure depicts how relationships among multiple factions may evolve dynamically based on maintained world state data, alignment vectors associated with NPCs, and probabilistic reasoning performed by an LLM. Factions may dynamically engage in power struggles, stability forecasting, alliances, and betrayals based on probabilistic survival modeling and emergent NPC decision-making.

A plurality of factions, including Faction A 305, Faction B 310, and Faction C 315, may represent groups of NPCs whose relationships are governed by the world state maintained by the game engine. Factions may engage in power struggles. Each faction may be associated with aggregated data derived from alignment vectors of NPCs belonging to that faction, including indicators of loyalty, hostility, influence, or reputation. These aggregated values may be provided as inputs to power struggle evaluation 320, which may represent a machine-readable assessment of relative faction strength, stability, or influence based on current world-state conditions and prior gameplay events. For example, an alignment vector may include a loyalty score of an NPC to a faction or leader. Various NPC types including faction leaders, merchants, citizens, soldiers, etc. may have alignment vectors.

In-game factions may evolve based on LLM-driven game theory modeling. The output of power struggle evaluation 320 may be provided to LLM stability prediction stage 325, where an LLM may evaluate the factional conditions using probabilistic reasoning. During this stage, the LLM may predict likely future states of faction stability or instability by considering factors such as power balance, historical alliances, recent conflicts, and changes in NPC alignment vectors. LLM stability prediction stage 325 may generate one or more control outputs that indicate potential faction-level outcomes.

Based on the control outputs generated by LLM stability prediction stage 325, the game engine may modify the world state to reflect faction-level decisions. As illustrated, such decisions may include alliances formed 330, in which two or more factions enter into cooperative relationships, or betrayals occur 335, in which existing alliances or cooperative relationships are weakened or terminated. These modifications may correspond to changes in relationship parameters stored in the world state and govern future interactions among NPCs associated with the respective factions. For example, relationship parameters may cause an NPC to initiate, terminate, strengthen, or weaken an affiliation.

The modified relationships may result in emergent outcome 340, which may represent a new world-state configuration reflecting updated factional dynamics. Emergent outcome 340 may influence subsequent gameplay events, NPC behavior, quest availability, or strategic conditions within the game. The emergent outcome may arise from programmatic evaluation and modification of world-state data rather than from pre-scripted faction logic.

The system may implement an evolutionary game theory model to determine NPC factional stability and interactions. NPC factions may evolve dynamically based on probabilistic faction survival modeling, diplomatic negotiations, and autonomous factional shifts. Probabilistic faction survival modeling may predict the relative success, stability, or decline of factions based on maintained world-state data. The probabilistic modeling may consider a power balance among factions derived from aggregated NPC attributes, including alignment vectors and indicators of NPC loyalty or influence within each faction. In addition, the modeling may incorporate game-world events such as conflicts, alliances, resource changes, or player actions that affect faction relationships. An LLM may evaluate these factors using probabilistic reasoning to generate predictions regarding faction survival, dominance, or fragmentation. The resulting predictions may be used by the game engine to modify world-state relationship parameters, enabling faction success or failure to emerge dynamically from gameplay conditions rather than predetermined scripts.

Diplomatic negotiations among NPCs may be determined based on predicted benefits derived from emergent game-theoretic analysis of the world state. Using probabilistic reasoning performed by an LLM, the system may evaluate potential outcomes of cooperation, neutrality, or conflict by considering factors such as relative faction strength, historical interactions, alignment vectors, and anticipated future gameplay conditions. Based on these evaluations, the game engine may modify world-state relationship parameters to reflect the formation of alliances, maintenance of cooperative arrangements, or execution of betrayals between factions or individual NPCs. These diplomatic outcomes are not defined by static rules or scripted events, but instead arise dynamically from ongoing assessment of predicted benefits and risks, enabling adaptive and context-sensitive faction behavior that evolves over time in response to gameplay events.

Autonomous factional shifts may occur as NPCs dynamically change rank, influence, or status within a faction based on adaptive reputation scoring maintained by the game engine. The reputation scoring may reflect accumulated gameplay outcomes, including prior interactions, alignment vector changes, loyalty indicators, and responses to game-world events or player actions. Using probabilistic reasoning performed by an LLM, the system may evaluate these reputation scores to determine whether an NPC should rise in rank, assume leadership roles, lose influence, or be demoted within the faction. These factional shifts may be applied by modifying NPC state and world-state relationship parameters, allowing hierarchical changes within factions to emerge organically over time. Such changes are not driven by predefined progression paths or scripted events, but instead result from continuous evaluation of maintained state data, enabling dynamic and adaptive faction hierarchies that respond to evolving gameplay conditions.

In specific embodiments, the process illustrated in FIG. 3 may implement an evolutionary game theory framework in which faction relationships evolve over time based on accumulated gameplay outcomes. The process of FIG. 3 may be repeated throughout gameplay. NPCs may autonomously rise or fall in faction rank, factions may gain or lose influence, and alliances may form or dissolve without explicit developer scripting. By repeatedly executing the faction evolution process shown in FIG. 3, the system enables long-term, adaptive faction dynamics driven by probabilistic modeling and persistent state updates, thereby supporting emergent strategic gameplay across gameplay sessions or game instances.

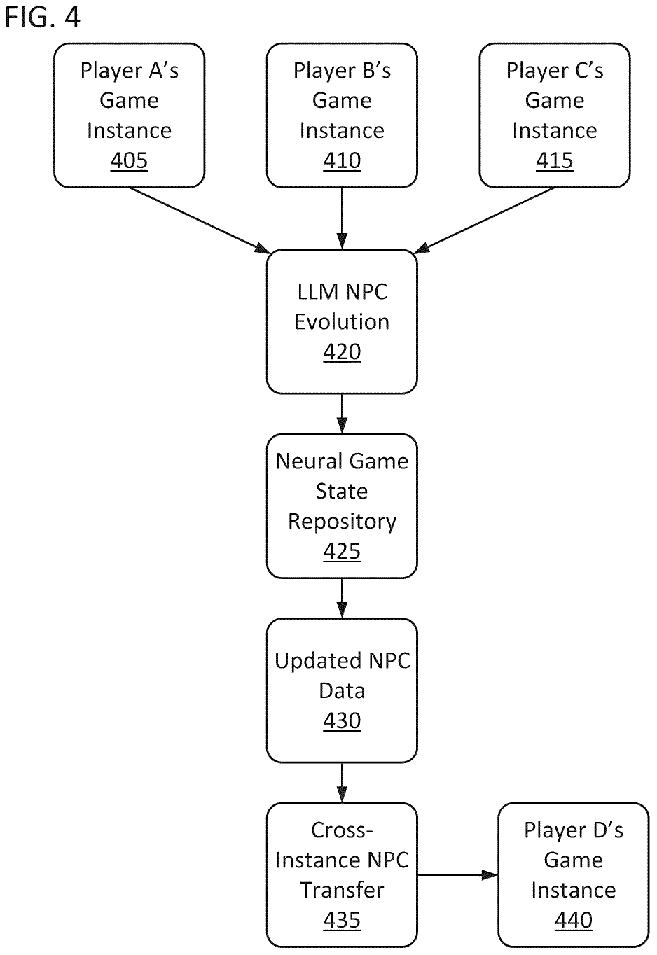

FIG. 4 illustrates an example architecture for cross-instance persistence of NPC evolution in a shared multiplayer or asynchronous gaming ecosystem in accordance with specific embodiments of the inventions disclosed herein. The figure depicts how NPC state information may be modified based on gameplay occurring in one or more game instances and subsequently applied to gameplay executed in a different game instance. This system allows NPCs to retain long-term memory beyond a single game session. A neural game state repository may store evolved faction data, character development (e.g., motives, aversions, phobias, passions), and inter-NPC relationships. In multiplayer or asynchronous gaming ecosystems, NPCs may be able to migrate between player sessions, bringing prior experiences and modified behaviors with them.

In the example of FIG. 4, Player A's game instance 405, Player B's game instance 410, and Player C's game instance 415 represent separate gameplay executions that may be associated with different users, different devices, or different gameplay sessions. During execution of each game instance, player interactions and in-game events affecting one or more NPCs may be processed by LLM NPC evolution module 420. LLM NPC evolution module 420 may execute an LLM configured to evaluate NPC state and world-state information using probabilistic reasoning and to generate control outputs that modify NPC attributes, alignment vectors, roles, or faction affiliations.

The modified NPC state information generated by the LLM NPC evolution module 420 may be stored in neural game state repository 425. Neural game state repository 425 may represent one or more persistent memory structures that store evolved NPC state data, including data representative of prior interactions, updated alignment vectors, faction relationships, and other attributes that influence NPC behavior (e.g., future behavior). Repository 425 may be implemented as a centralized or distributed data store accessible by multiple game instances and is not limited to a particular storage format. For example, neural game state repository 425 may be implemented using one or more persistent storage systems such as a database, key-value store, object store, or distributed data storage service accessible by multiple game instances.

From neural game state repository 425, updated NPC data 430 may be retrieved and prepared for reuse. Updated NPC data 430 may represent NPC state information that has been modified based on gameplay occurring in game instances 405, 410, 415, or a combination thereof. Stored NPC data may include machine-readable representations of NPC state, such as alignment vectors, reputation or loyalty scores, faction affiliations, relationship parameters, and data representative of prior in-game interactions.

Through cross-instance NPC transfer process 435, updated NPC data 430 may be provided to another game instance, such as Player D's game instance 440, during gameplay execution. Game instance 440 may incorporate the updated NPC data into its maintained NPC states and world state, thereby influencing NPC behavior and faction relationships experienced by players including Player D as well as future game instances (not shown) of Player A, B, and C. During initialization or runtime execution of a receiving game instance, the cross-instance NPC transfer process may retrieve selected NPC data from the repository based on identifiers, relevance criteria, or gameplay context, and may transmit the data to the receiving game engine. The receiving game engine may integrate the transferred NPC data into its maintained NPC states and world state by updating corresponding data structures, thereby influencing subsequent NPC behavior, dialogue, and interactions within the receiving game instance. The transfer process may occur asynchronously, without requiring simultaneous execution of the originating and receiving game instances, and may include validation, versioning, or policy checks to ensure consistency with gameplay rules. In this manner, NPC evolution achieved through gameplay in one instance may be persistently stored, selectively transferred, and programmatically applied in other game instances, enabling cross-player and cross-session continuity of NPC behavior without reliance on pre-scripted synchronization.

In specific embodiments, the cross-instance NPC persistence illustrated in FIG. 4 may be implemented within a shared game world accessed by a defined group of players. For example, Player A, Player B, Player C, and Player D may be authorized participants in the same game world, where access to the game world is controlled through invitations, access codes, account associations, or similar authorization mechanisms. In specific embodiments, players may not be required to be present concurrently for gameplay to occur, and gameplay actions performed by one player may modify NPC state information that influences subsequent gameplay experienced by other authorized players at a later time (e.g., in a subsequent game instance) in that same game world. In addition to NPC state information, other maintained game-state data—such as item states, quest states, event conditions, faction standings, or other game artifacts—may likewise be modified in one gameplay execution and persistently stored for application in later gameplay executions. For example, an item generated or modified in one player's session may retain evolved attributes or contextual associations when encountered by another player, and a world event triggered in one session may remain active or influence quest availability in subsequent sessions. In alternative embodiments, the shared game world may be implemented as an open or semi-open online environment in which multiple players may freely enter, exit, and interact with the game world without explicit invitations. In both cases, NPC state information, item state information, event state information, and world state data may be persistently stored and retrieved across gameplay executions, enabling coordinated evolution of characters, factions, artifacts, and gameplay structures in a shared environment regardless of whether players interact synchronously or asynchronously.

By enabling NPC state information to be modified in one gameplay instance and subsequently applied in a different gameplay instance, the system illustrated in FIG. 4 supports persistent NPC evolution across players, sessions, and game instances. NPCs may therefore exhibit continuity of behavior, reputation, or affiliation that reflects accumulated gameplay history rather than isolated, session-specific interactions. NPCs may persist across multiple game instances using an LLM-driven neural game state repository. Player actions in one game instance may modify NPC attributes, relationships, and faction alignments, which may then be retrieved and applied dynamically in new player sessions. This cross-instance persistence enables shared world progression and emergent multiplayer narratives without requiring pre-scripted synchronization or manual developer control.

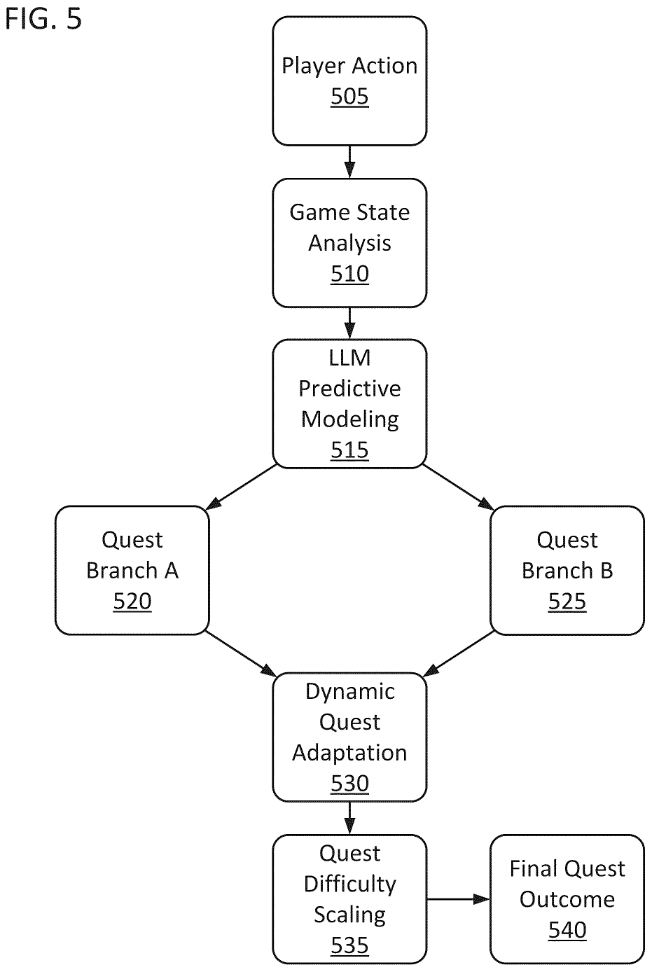

FIG. 5 illustrates an example process for dynamic quest generation and adaptation using LLM-driven predictive modeling in accordance with specific embodiments of the inventions disclosed herein. Quest structures may dynamically adjust based on player choices. The process shown in FIG. 5 may be executed by a game engine during runtime gameplay and may enable quest structures to evolve in response to player actions, maintained game state, and probabilistic predictions generated by the LLM. In the LLM-driven quest generation system, player actions and game state analysis may influence procedural quest creation. The model may predict engaging quest structures, allowing for dynamic quest branching, real-time adaptation, and difficulty scaling based on emergent gameplay. The LLM may analyze player behavior patterns and generate missions tailored to: player engagement levels and playstyle, prior in-game decisions and faction affiliations, and procedural storytelling to ensure unique experiences in every playthrough.

At step 505, a player action is received during gameplay. The player action may include completion of an objective, interaction with an NPC, selection of a dialogue option, participation in combat, or another gameplay event. The player action may be provided to game state analysis stage 510, where the game engine may evaluate the current game state, including world state data, NPC states, alignment vectors, faction relationships, and prior gameplay history relevant to quest progression.

Based on the analyzed game state, the process may proceed to an LLM predictive modeling stage 515. During this stage, an LLM may evaluate the player action and the analyzed game state using probabilistic reasoning to predict one or more quest progression paths. LLM predictive modeling stage 515 may generate control outputs indicating potential quest branches, outcomes, or adaptations that are expected to align with current gameplay conditions, player behavior patterns, and evolving world-state relationships.

Predictive modeling stage 515 may result in selection or generation of different quest branches, such as Quest Branch A 520 or Quest Branch B 525. Each quest branch may represent a distinct set of objectives, constraints, or narrative conditions that may be applied based on the predicted impact of the player action and the current world state. The branching is not predefined by static quest trees, but instead is determined dynamically based on probabilistic evaluation performed by the LLM.

Following selection of a quest branch, the process proceeds to dynamic quest adaptation 530, where the selected quest may be modified or refined based on additional gameplay factors, such as NPC alignment vectors, faction affiliations, or recent changes to the world state. Dynamic quest adaptation 530 may include adjusting objectives, modifying success conditions, or altering quest dependencies to reflect emergent gameplay conditions. In this manner, quest structures may be treated as machine-readable data objects that can be updated programmatically rather than as fixed scripts.

The adapted quest structure may then be subjected to quest difficulty scaling 535, where one or more gameplay parameters governing challenge level, reward allocation, or pacing may be adjusted based on the control outputs generated by the LLM. The difficulty scaling may consider player engagement level, prior performance, or world-state conditions to ensure balanced and context-appropriate gameplay. The resulting adjustments may be applied by modifying game-state parameters rather than directly manipulating player input.

In specific embodiments, a difficulty level may not be represented as a single scalar value, but instead may comprise a plurality of independently adjustable difficulty aspects corresponding to different gameplay dimensions. Such difficulty aspects may include, for example, combat intensity, enemy behavior complexity, resource scarcity, negotiation success thresholds, puzzle complexity, time constraints, or social interaction requirements with NPCs or factions. The game engine may adjust each difficulty aspect independently based on LLM-generated control outputs derived from player performance data and engagement analysis. For instance, a first player who exhibits difficulty in combat interactions may experience reduced enemy aggressiveness or simplified attack patterns, while maintaining higher difficulty for strategic planning and narrative decision-making. Conversely, a second player who struggles with diplomatic negotiations or faction leadership interactions may receive modified negotiation parameters, such as increased tolerance for suboptimal dialogue choices or alternative alliance pathways, without reducing combat difficulty. Additional examples include adjusting stealth detection sensitivity for players challenged by stealth mechanics, modifying economic pressures for players who struggle with resource management, or altering puzzle hint frequency for players who exhibit delayed progression. By treating difficulty as a set of separable, machine-readable parameters rather than a uniform setting, the system enables personalized gameplay experiences that adapt dynamically to individual player strengths, weaknesses, inferred emotional state, or inferred intents, while preserving overall game balance and challenge across diverse playstyles.

In specific embodiments, the LLM may function as a runtime orchestration component that not only evaluates game-state data but may also infer a player's emotional state (e.g., engagement profile) based on observable gameplay behavior. For example, the system may analyze player performance metrics, interaction patterns, pacing, strategic choices, dialogue selections, and other measurable indicators to approximate a player's current engagement level or gameplay disposition. Based on this inferred engagement profile, the LLM may generate control outputs that modify NPC states, world-state relationships, quest structures, item attributes, or gameplay parameters so that the evolving game state aligns with the player's inferred experience. In this manner, the system may adapt not merely to external game events, but to patterns of player interaction reflected in maintained state data, enabling coordinated modification of encounters, narrative elements, faction dynamics, and reward structures. Unlike conventional branching narrative systems that follow predetermined logic paths, the disclosed architecture allows dynamic, probabilistic alignment between maintained game-state data and inferred player engagement characteristics, thereby enabling emergent storytelling and context-sensitive gameplay evolution grounded in programmatic state modification. For example, the system may align game states with emergent story awareness, emotional antagonism, metaphorical reasoning, archetypal patterns, and even internal mythologies.

The adaptive quest generation process may result in final quest outcome 540, which may represent the quest configuration presented during gameplay, including adapted objectives, difficulty level, and expected rewards. Final quest outcome 540 may influence subsequent gameplay events, NPC behavior, or world-state conditions and may be stored as part of the maintained game state for use in later gameplay execution.

Through the process illustrated in FIG. 5, quest generation and progression are dynamically controlled using LLM-driven predictive modeling that evaluates player actions and maintained game state. The process of FIG. 5 may be repeated throughout gameplay. This approach enables adaptive quest structures that respond to player choices, prior in-game decisions, and faction affiliations, while remaining grounded in concrete operations such as state analysis, probabilistic prediction, and programmatic modification of gameplay parameters.

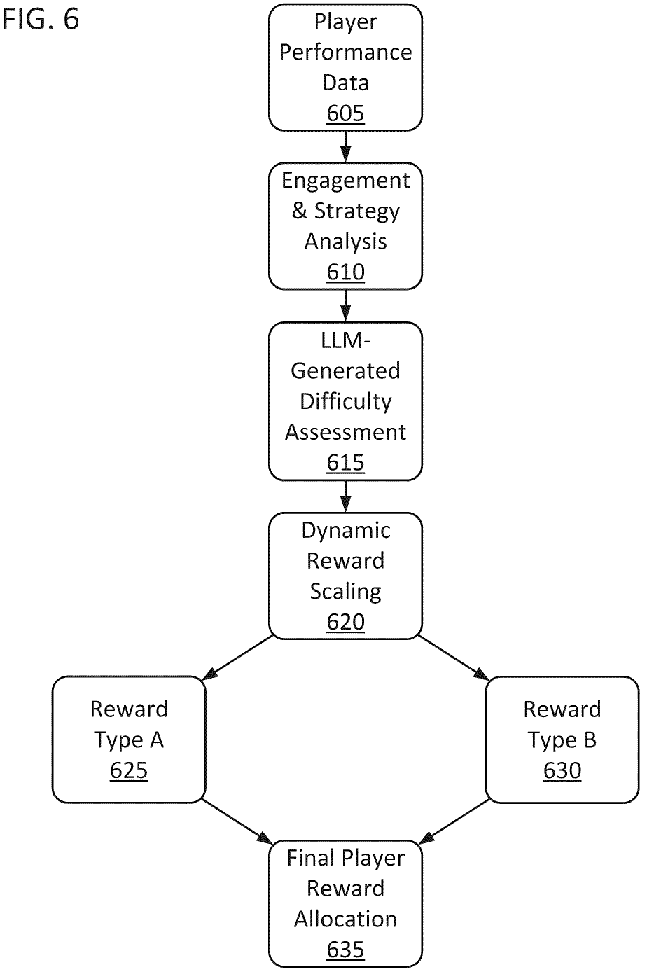

FIG. 6 illustrates an example process for an adaptive player reward system driven by LLM-generated engagement and difficulty metrics in accordance with specific embodiments of the inventions disclosed herein. The process shown in FIG. 6 may enable dynamic adjustment of rewards based on player performance, engagement, and strategic behavior, rather than relying on fixed reward tables or predefined difficulty heuristics. The LLM may evaluate player behavior, predict optimal challenge levels, and scale rewards accordingly, ensuring an adaptive and balanced game experience.

At step 605, player performance data may be collected during gameplay execution. The player performance data may include machine-readable metrics such as completion time, success or failure rates, resource usage, decision patterns, interaction frequency, or other indicators of player behavior and gameplay progression. The player performance data may be provided to engagement and strategy analysis stage 610, where the game engine may analyze the data to determine measures of player engagement, playstyle, and strategic complexity in view of current game-state and world-state conditions.

The analyzed engagement and strategy information may then be provided to the LLM-generated difficulty assessment stage 615. During this stage, an LLM executed by the computing system may evaluate the player performance data and the engagement and strategy analysis in conjunction with maintained game-state information, such as current world-state conditions, recent gameplay outcomes, and applicable gameplay policies. Using probabilistic reasoning, the LLM may generate one or more control outputs representing an assessed difficulty level or a predicted challenge requirement for the player. The assessed difficulty level may be expressed as one or more machine-readable parameters, scores, or ranges that indicate an appropriate level of challenge for subsequent gameplay interactions. Unlike predefined difficulty tiers or static heuristics, the LLM-generated difficulty assessment reflects emergent gameplay conditions and evolving player behavior patterns, enabling the game engine to adapt challenge levels dynamically in response to changes in player performance, engagement, or strategic decision-making over time.

Based on the difficulty assessment generated by the LLM, the process may proceed to dynamic reward scaling 620. At this stage, one or more gameplay parameters governing reward allocation may be adjusted programmatically by the game engine. The reward scaling may include determining different reward types, quantities, or attributes that correspond to the assessed difficulty and engagement level. As illustrated, the reward scaling process may result in selection or generation of different reward categories, such as reward type A 625 or reward type B 630, each representing a distinct reward structure or incentive aligned with the player's current gameplay context. A “reward” may be interpreted broadly to include not only tangible in-game items or numerical incentives, but also intangible or contextual benefits, such as providing hints or guidance during a puzzle, increasing trust or reputation levels with an NPC, unlocking dialogue options, reducing future difficulty thresholds, or otherwise modifying gameplay conditions in a manner beneficial to the player or otherwise modifying gameplay conditions in a manner responsive to the player's inferred emotional state.

The dynamically scaled rewards may be selected or combined to produce final player reward allocation 635, which may represent the reward presented to the player during gameplay. The final player reward allocation may include in-game items, experience points, resources, or other incentives, and may influence subsequent gameplay behavior, progression, or challenge level. In specific embodiments, the reward allocation and associated parameters may be stored as part of the maintained game state for use in later gameplay execution.

Through the process illustrated in FIG. 6, player rewards are adapted dynamically based on LLM-generated engagement and difficulty assessments that account for emergent gameplay depth and strategic complexity. The process of FIG. 6 may be repeated throughout gameplay. This approach enables balanced and responsive reward allocation that adjusts to different player skill levels and playstyles while remaining grounded in concrete operations such as performance data collection, state analysis, probabilistic model execution, and programmatic modification of gameplay parameters. Unlike traditional fixed rewards, the LLM may calculate reward difficulty scaling based on emergent gameplay depth, engagement, storytelling aspects such as archetypes, metaphors, and mythologies, and strategic complexity rather than predefined heuristics. This allows for adaptive difficulty tuning, ensuring an engaging experience for all player skill levels.

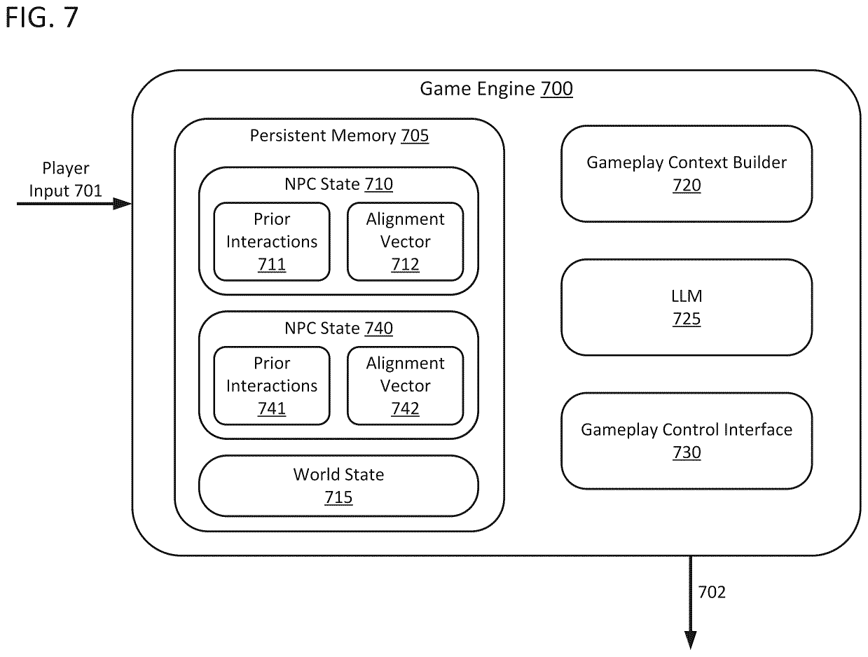

FIG. 7 illustrates an example implementation of game engine 700 configured to control gameplay in an interactive computer game in accordance with specific embodiments of the inventions disclosed herein. As shown, methods of controlling gameplay are computer-implemented. Game engine 700 may be executed by a computing system including one or more processors and memory and may receive player input 701 representing or indicating player actions during gameplay execution. Although FIG. 7 shows persistent memory 705 implemented within the game engine 700, in other embodiments persistent memory 705 may be implemented as one or more external or distributed storage systems accessible to game engine 700.

Game engine 700 may be configured to maintain persistent memory 705 that stores machine-readable data structures representing gameplay state. In the illustrated embodiment, persistent memory 705 stores a plurality of NPC states and world state 715. Although two NPC states, NPC state 710 and NPC state 740, are shown, the game engine may maintain any quantity of NPC states. Each NPC state may include data representative of prior in-game interactions with the corresponding NPC. Each NPC state may further include an alignment vector of the corresponding NPC, where the alignment vector may comprise a plurality of machine-readable values encoding tendencies or affiliations of the NPC relative to at least one other NPC, faction, or player character. In specific embodiments, the alignment vector and the prior interaction data may be stored within a neural memory structure, which may be implemented within or accessible to persistent memory 705. In specific embodiments, portions of the alignment vector and portions of the prior interaction data may be stored within persistent memory 705 while other portions may be stored elsewhere.

Each NPC state may correspond to an NPC of a plurality of NPCs. In the example of FIG. 7, NPC state 710 includes prior interactions data 711 and alignment vector 712. NPC state 740 includes prior interactions data 741 and alignment vector 742. The interaction data and alignment vector may be specific to each NPC. In some embodiments, a plurality of NPCs may be associated with a shared NPC state, allowing groups of NPCs to exhibit coordinated behavior without requiring separate state maintenance for each individual character. For example, background NPCs such as townsfolk, guards, or civilians may be represented collectively by a common NPC state that includes shared alignment vectors and data representative of prior interactions. In such embodiments, modifications to the shared NPC state may cause the group to respond collectively to changes in the world state, such as aligning with, supporting, or betraying a particular ruler or faction. By enabling groups of NPCs to share an NPC state, the system reduces computational overhead while allowing large-scale population behavior, such as mass loyalty shifts or collective unrest, to emerge dynamically based on gameplay events rather than predefined scripts. The world state may comprise aggregated data derived from alignment vectors of multiple NPCs and may represent a relationships between different factions of the different NPCs. Based on an inferred emotional state of the player, the system could modify the world state or alignment vectors to create a story to either advance or inhibit certain outcomes that aligns with the inferred emotional state. Modifying the world state may comprise altering at least one relationship parameter governing interactions between at least two NPCs. Additionally, modifying the world state may comprise altering at least one relationship parameter governing interactions between a first group (e.g., faction) of NPCs and a second group (e.g., faction) of NPCs.

World state 715 maintained by the game engine 700 may be a data structure that represents aggregated conditions or relationships derived from a plurality of NPCs, factorions, or regions and may govern interaction rules or constraints applicable to NPCs during gameplay. For example, worlds state 715 may comprise aggregated data derived from alignment vectors of multiple NPCs and may govern relationships between NPCs, between groups of NPCs, or between NPC factions and player characters. World state 715 may include relationship parameters, faction affiliations, reputation indicators, or other machine-readable values that influence interactions among entities within the game world. In specific embodiments, the world state may govern relationships among a plurality of NPCs by aggregating and evaluating alignment vectors associated with the NPCs. Each alignment vector may encode machine-readable values representing tendencies, loyalties, affiliations, or dispositions of an NPC relative to other NPCs, factions, or player characters. The world state may derive relationship parameters—such as cooperation levels, hostility thresholds, trust scores, or faction affiliations—based at least in part on these alignment vectors, either individually or in aggregate across groups of NPCs. As alignment vectors are modified over time in response to gameplay events or control outputs generated by the LLM, the world state may be correspondingly updated to reflect changes in how NPCs relate to one another. In this manner, the world state may function as a centralized relationship model that programmatically governs NPC interactions, enabling shifts in alliances, rivalries, or collective behavior to emerge dynamically from underlying alignment data rather than from static or pre-scripted rules.

In one example of NPC memory and adaptive storytelling, a player character's actions influence how NPCs interact with the player character. NPCs may maintain persistent memory that enables adaptive storytelling and context-aware interactions over time. For example, an NPC merchant may store data representative of a player's prior interactions, such as past purchases, negotiation outcomes, or patterns of cooperation, within the NPC's maintained state and alignment vector. Based on this stored interaction history, the merchant may dynamically adjust future behavior, such as modifying pricing, offering exclusive items, or changing dialogue options in response to the player's established purchasing relationship. In a subsequent gameplay scenario, if the player takes an action that alters the world state—such as betraying a faction allied with the merchant—the LLM may evaluate the updated alignment information and generate control outputs that cause the merchant to further adapt behavior, including refusing service, restricting access, or altering affiliations. The world state may comprise aggregated data derived from the alignment vector of at least one NPC state (e.g., the of merchant) and may represent a relationship between a faction of the corresponding NPC and a player character. Through this mechanism, long-term NPC memory and evolving world-state relationships may influence gameplay outcomes and narrative progression in a cohesive and emergent manner, rather than through isolated or pre-scripted interactions.

In one example of NPC memory, inferred player-state adaptation, and adaptive storytelling, a computing system may first infer an emotional or engagement state of a player based on observable gameplay behavior, including pacing patterns, repetition of actions, hesitation intervals, negotiation patterns, combat performance metrics, resource usage trends, dialogue selections, or other machine-readable interaction data. Using probabilistic reasoning performed by a machine intelligence model (e.g., a large language model), the system may generate an inferred emotional state profile representing, for example, frustration, confidence, curiosity, aggression, caution, boredom, immersion, or strategic deliberation. This inferred emotional state may be incorporated into maintained NPC states, alignment vectors, or world-state evaluations and may influence generation of control outputs. NPCs may maintain persistent memory that enables adaptive storytelling and context-aware interactions over time. For example, an NPC merchant may store data representative of a player's prior interactions, such as past purchases, negotiation outcomes, or patterns of cooperation, within the NPC's maintained state and alignment vector, and may further associate such data with the inferred emotional state profile. Based on this stored interaction history and inferred player state, the merchant may dynamically adjust future behavior, such as modifying pricing, offering exclusive items, providing hints, altering tone, escalating tension, or changing dialogue options in response not only to the player's transactional history but also to the player's inferred engagement condition. In a subsequent gameplay scenario, if the player takes an action that alters the world state—such as betraying a faction allied with the merchant—the probabilistic decision model may evaluate the updated alignment information in conjunction with the inferred emotional state and generate control outputs that cause the merchant to further adapt behavior, including refusing service, restricting access, altering affiliations, expressing distrust, or strategically manipulating interactions to influence player disposition. The world state may comprise aggregated data derived from the alignment vector of at least one NPC state (e.g., the merchant) and may represent a relationship between a faction of the corresponding NPC and a player character. Through this mechanism, inferred player state, long-term NPC memory, and evolving world-state relationships may collectively influence gameplay outcomes and narrative progression in a cohesive and emergent manner, rather than through isolated or pre-scripted interactions.

In one example of emergent NPC diplomacy, a player character's actions how NPCs interact with one another within the game world. For instance, in a strategy-based game environment involving multiple competing factions, a player may engage in trade, negotiation, or conflict with two rival factions over time. Based on accumulated prior interactions and changes to alignment vectors associated with NPCs belonging to each faction, an LLM may evaluate faction stability and predict the likely outcomes of continued cooperation or conflict. The game engine may then modify the world state to reflect dynamic shifts in alliances, rivalries, or power balances between the factions. The world state may comprise aggregated data derived from alignment vectors of a first NPC and a second NPC and may represent a relationship between a first faction of the first NPC and a second faction of the second NPC. Modifying the world state may comprise altering at least one relationship parameter governing interactions between the first NPC and the second NPC. Additionally, modifying the world state may comprise altering at least one relationship parameter governing interactions between a first group of NPCs and a second group of NPCs. As an example, a player may trade with, and thus strengthen one faction. This may cause that faction to gain power and invade a second faction. The player's choices can cause factions to form alliances with or betray each other independently of the player's direct involvement, thereby reshaping the political structure of the game world through emergent NPC diplomacy rather than scripted events. The world state may govern gameplay outcomes affecting a plurality of NPCs concurrently.

In one example of cross-instance NPC continuity, a player character's actions influence how NPCs interact with other player characters within the game world. For example, the system may persist NPC state information beyond a single gameplay execution and applying that information across different players'game instances. For example, an NPC leader may gain influence, authority, or rank as a result of gameplay actions performed by a first player, such as completing quests, forming alliances, or supporting the NPC's faction. The resulting changes to the NPC's state—including updated alignment vectors, reputation scores, or leadership status—may be stored in persistent memory accessible to multiple game instances. When a second, different player later encounters the same NPC in a separate game instance, the game engine may retrieve the persisted NPC state and incorporate it into the current world state, causing the NPC to exhibit behavior consistent with the evolved status. As a result, the NPC may interact differently with the second player, issue commands, influence faction dynamics, or alter available gameplay options opposed to if the first player hadn't performed their actions. This cross-instance continuity enables a shared narrative experience in which NPCs reflect accumulated history across multiple players, allowing the game world to evolve collectively rather than resetting independently for each player.

During gameplay execution, game engine 700 may provide portions of the maintained NPC states and world state 715 to gameplay context builder 720. Gameplay context builder 720 may select a subset of the plurality of NPC states based on relevance to a current gameplay condition, including relevance to a player action received via player input 701. Gameplay context builder 720 may assemble a current gameplay context that may include one or more NPC states (e.g., alignment vectors) and relevant world-state information.

The assembled gameplay context may be provided to LLM 725, which may be executed during runtime execution of game engine 700. LLM 725 may evaluate world state 715 and at least one NPC state (e.g., the subset of selected NPCs states) using probabilistic reasoning and may generate one or more control outputs. In specific embodiments, generation of the control outputs may be triggered by a player action received via player input 701. LLM 725 operates as a decision authority that determines modifications to the world state during the execution of the game engine rather than generating static scripted content.

In specific embodiments, the probabilistic reasoning performed by LLM 725 may be constrained by one or more gameplay policies enforced by game engine 700. This may allow the control outputs generated by the model to remain consistent with predefined gameplay rules, balance requirements, and system constraints. These gameplay policies may be implemented as machine-readable rules, thresholds, permissions, or guardrails that limit or shape how LLM 725 evaluates game state and proposes modifications to NPC behavior or world state. For example, a gameplay policy may prevent LLM 725 from eliminating a critical NPC required for narrative continuity, from forming alliances that would break core faction logic, or from assigning rewards beyond permitted ranges. In other examples, policies may constrain the rate at which alignment vectors can change, limit how frequently factions can switch allegiances, or enforce minimum difficulty or fairness levels across players. Game engine 700 may apply these policies either before invoking LLM 725, by filtering or structuring the input context, or after control outputs are generated, by validating, modifying, or rejecting outputs that violate policy constraints. By constraining probabilistic reasoning with gameplay policies, the system preserves designer intent, game balance, and technical consistency while still enabling adaptive, emergent behavior driven by the LLM.

The generated control outputs may be provided to gameplay control interface 730, which may apply the control outputs to modify gameplay state. In particular, gameplay control interface 730 may modify world state 715 based on the control outputs. Modifying the world state may include altering one or more relationship parameters governing interactions between individual NPCs, between groups (e.g., factions) of NPCs, between individual NPCs and player characters, or between groups of NPCs and player characters.

In specific embodiments, modifying the world state may be performed indirectly. For example, modifying the world state may include modifying one or more alignment vectors based on the control outputs, performing one or more NPC actions based on the modified alignment vectors, and updating the world state based on the NPC actions. For example, a player completes a mission that benefits a rebel faction at the expense of a ruling empire. During gameplay execution, the LLM generates control outputs indicating that NPCs aligned with the empire should reassess their loyalties based on the player's actions and recent world events. In response, the game engine modifies one or more alignment vectors associated with affected NPCs, such as reducing loyalty values toward the empire and increasing distrust or hostility values toward rebel-aligned NPCs. Based on the modified alignment vectors, the NPCs then perform actions consistent with the updated state, such as withdrawing support from imperial leaders, refusing cooperation with loyalist NPCs, or initiating covert communications with opposing factions. These NPC actions generate gameplay interaction events that are processed by the game engine to update the world state, for example by weakening the empire's faction stability, altering diplomatic relationships, or triggering new conflict conditions. As a result, the world state may reflect the cumulative effect of the alignment vector modifications and NPC actions, enabling faction dynamics and NPC relationships to evolve organically in response to player-driven events. In specific embodiments, there may be a time delay between the change in the alignment vectors and the change in the world state. For example, the NPCs may spend time planning a revolt before a revolt takes place. In other embodiments, the alignment vectors and the world state may change effectively at the same time. For example, soldiers may abandon their posts in a conflict, result in immediate weakening of the faction.

In specific embodiments, game engine 700 may persist the modified world state and modified NPC states within persistent memory 705 for use in subsequent gameplay executions (e.g., a different game session or game instance). Such persistence may allow modified world states and modified NPC states resulting from gameplay by a first user to be applied during gameplay execution for a second user different from the first user.

In specific embodiments, modifying world state 715 may comprise generating or updating at least one player objective (e.g., quest). Gameplay control interface 730 may adjust one or more gameplay parameters governing reward allocation or difficulty level based on the control outputs generated by LLM 725. Such adjustments may be applied indirectly through modification of the world state or related gameplay parameters rather than through direct manipulation of player input.

During runtime execution, game engine 700 may produce output 702 that may represent the applied results of gameplay state evaluation and modification. Output 702 may include updated gameplay behavior and states generated by the game engine based on maintained NPC states, world state, and control outputs produced by the LLM. Output 702 may include observable NPC actions and dialogue presented during gameplay, such as changes in NPC behavior, availability, or interaction patterns. Output 702 may further include modified world-state data that governs relationships among NPCs, including changes to faction affiliations, alliances, hostilities, or other relationship parameters. In addition, the game engine output may include updated NPC state information written to persistent memory, such as modified alignment vectors or records of prior interactions, enabling continuity across gameplay executions. In some embodiments, output 702 may include adjusted gameplay parameters or player objectives, such as updated reward allocation, difficulty settings, or quest structures, which influence subsequent gameplay execution. In this manner, output 702 represents the concrete, machine-readable effects of the game engine's application of control outputs, rather than abstract decisions or narrative content.

Through the configuration illustrated in FIG. 7, game engine 700 may maintain NPC states and world state, execute an LLM using probabilistic reasoning, and modify the world state based on generated control outputs, thereby enabling adaptive, persistent, and context-aware gameplay behavior without reliance on pre-scripted rules. Gameplay context builder 720 may retrieve NPC states 710 and 740 as well as world state 715. LLM 725 may evaluate the context generated or provided by gameplay context builder 720 to generate or predict control outputs. Gameplay control interface 730 may apply the control outputs of LLM 725 to update world state 715, NPC state 710, and NPC state 740.

In specific embodiments, the game engine may maintain a plurality of item states for each of a plurality of in-game items, which may function similarly to the NPC states for the plurality of NPCs as described herein. Each item state may comprise one or more machine-readable data structures that store attributes and contextual information associated with the corresponding item. The item state may include, for example, statistical parameters (e.g., damage values, durability, modifiers, rarity tier), visual attributes (e.g., assigned sprite identifiers, shader parameters), descriptive data (e.g., item name, lore text), and usage-related information (e.g., acquisition history, ownership, prior in-game interactions, or contextual associations with NPCs or factions). In specific embodiments, the item state may further include alignment-related or contextual vectors indicating how the item is associated with particular factions, regions, or gameplay conditions. The item state may be stored in persistent memory and may be updated during runtime execution of the game engine based on control outputs generated by an LLM, player actions, or changes in world state. By maintaining and modifying item state in this manner, the system enables items to evolve dynamically in response to gameplay events rather than remaining static predefined assets.

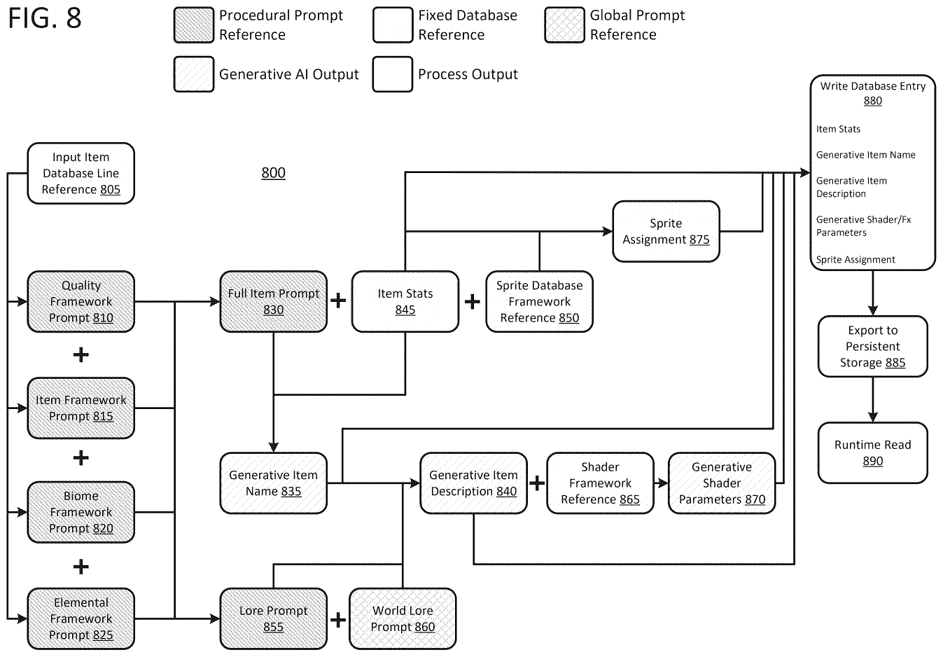

FIG. 8 illustrates lore machine 800 in accordance with specific embodiments of the inventions disclosed herein. Lore machine 800 represents an example embodiment of the gameplay control architecture described herein, in which an LLM is applied to structured world state and persistent entity state to generate and persist game content. While FIG. 8 illustrates item and lore generation, the same architectural principles may be applied to NPC behavior, faction dynamics, and other world-level gameplay elements as described throughout the specification.

FIG. 8 illustrates an example of a procedural-generative content generation system that operates as an embodiment of the gameplay control architecture described herein. In the illustrated embodiment, the system generates and persists in-game items by combining structured prompt inputs, fixed framework references, and generative outputs produced by an LLM, and by storing the resulting item data for use during gameplay execution. Boxes in FIG. 8 are categorized into procedural prompt references, fixed database references, global prompt references, generative AI output, and process outputs.

As shown on the left side of the figure, one or more procedural prompt references are assembled to define a generation context. These prompt references may include, for example, quality framework prompt 810, item framework prompt 815, biome framework prompt 820, and elemental framework prompt 825, which may be optionally anchored to input item database line reference 805. Input item database line reference 805 may provide a reference to an existing item record or template that anchors generation to predefined item metadata or archetypes. Quality framework prompt 810 may define quality-related constraints, such as rarity, tier, or balance parameters, that guide item generation. Item framework prompt 815 may specify structural attributes of the item, including item class, functional role, or gameplay mechanics. Biome framework prompt 820 may constrain item generation based on environmental or regional context within the game world. Elemental framework prompt 825 may apply elemental or thematic attributes that influence item properties and interactions. In some embodiments, prompts 810, 815, 820, and 825 may be derived from or influenced by world state or gameplay conditions. Collectively, prompts 810, 815, 820, and 825 may be combined to produce full item prompt 830, which may represent a machine-readable description of constraints, attributes, and contextual factors relevant to item generation. Full item prompt 830 may define the item generation context.

Full item prompt 830 may be provided to an LLM, which may generate one or more control outputs in the form of generative content, such as generative item name 835 and generative item description 840. Generative item name 835 may represent a name generated by the LLM that reflects the item's attributes and context. Generative item description 840 may represent descriptive text generated by the LLM that incorporates item attributes and world lore.

In parallel, item statistics 845 may be determined based on predefined rules or mappings, and sprite database framework references 850 may be used to guide visual asset selection. Item statistics 845 may specify numerical or categorical gameplay parameters associated with the item, such as damage, durability, or modifiers. Sprite database framework reference 850 may identify a set of visual asset constraints or references used to select or assign an appropriate sprite. The outputs generated by the LLM and associated framework references may be applied through sprite assignment 875. Sprite assignment 875 may select and associate a specific sprite asset with the generated item based on item attributes and visual constraints.

In addition, lore prompt 855 may be combined with world lore prompt 860 to ensure that generated descriptions are consistent with the broader game world. Lore prompt 855 may provide narrative or descriptive constraints used to guide generation of item descriptions. World lore prompt 860 may represent global narrative constraints derived from the world state and may supply global narrative context derived from the game world to ensure consistency across generated content.

The LLM may also generate shader parameters 870 or other visual-effect parameters by evaluating the generative item description 840 in conjunction with shader framework reference 865. Shader framework reference 865 may identify visual-effect constraints or templates used to guide shader or effect parameter generation. Generative shader parameters 870 may specify generated visual-effect parameters applied to the item for rendering or presentation.

The outputs generated by the LLM and associated framework references may be consolidated into a structured database write operation. Write database entry 880 may include item statistics 845, generative item name 835, generative item description 840, generated shader (or effects) parameters 870, and sprite assignment 875. This write operation may represent a modification of persistent game data structures, in connection with modifying world state or gameplay parameters based on control outputs generated by an LLM. Write database entry 880 may persist the generated item data to storage.

The generated item data may then be exported to persistent storage 885, such as a SQLite database, and made available for runtime read operations 890. Export to persistent storage 885 may serialize and store the item data in a persistent database format accessible during gameplay execution. Runtime read operations 890 may retrieve the stored item data during gameplay events, such as loot generation or item acquisition. In this manner, the generative outputs are not transient narrative content but are persisted as machine-readable game data that influences subsequent gameplay execution. Lore machine 800 demonstrates a concrete embodiment in which an LLM operates as a decision and generation component whose outputs are constrained by gameplay policies, integrated with maintained state, and stored for reuse.

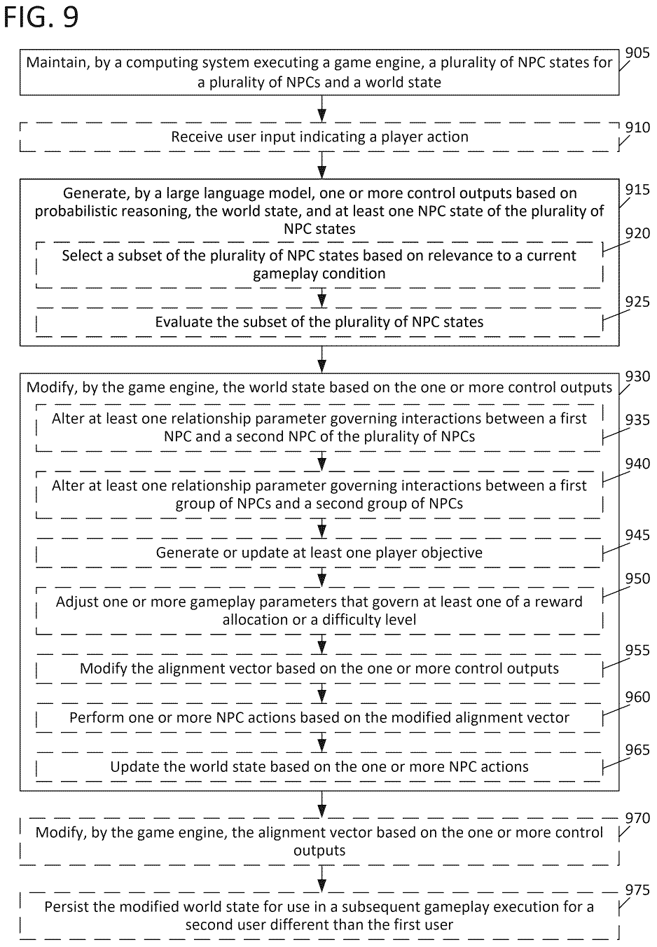

FIG. 9 provides an example of method 900 for controlling gameplay in an interactive computer game in accordance with specific embodiments of the inventions disclosed herein. Method 900 may be computer-implemented. Method 900 may be implemented by a computing system including one or more processors and memory. The one or more processors and memory may execute a game engine and an LLM. Method 900 may be implemented by a system including a non-transitory computer-readable medium having instructions stored thereon, that when executed by one or more processors of a computing system, cause the one or more processors to perform operations of method 900. Method 900 may be implemented by a system including means for performing the steps of method 900. Steps, or portions of steps, of method 900 may be duplicated, omitted, rearranged, or otherwise deviate from the form shown. Additional steps may be added to method 900. Steps, or portions of steps, of method 900 may be performed in series or parallel.

At step 905, a computing system executing a game engine may maintain a plurality of NPC states (for a plurality of NPCs) and a world state. Each NPC state of the plurality of NPC states may: (i) correspond to an NPC of the plurality of NPCs, (ii) include data representative of prior in-game interactions with the corresponding NPC, and (iii) include an alignment vector of the corresponding NPC. In specific embodiments, the alignment vector may comprise a plurality of machine-readable values encoding tendencies or affiliations of the corresponding NPC relative to at least one other NPC, faction, or player character. In specific embodiments, at least part of the alignment vector may be stored in a neural memory structure. The world state may govern relationships among the plurality of NPCs based at least in part on the alignment vectors of the plurality of NPCs. In specific embodiments, the world state may comprise aggregated data derived from alignment vectors of a first NPC and a second NPC of the plurality of NPCs and may represent a relationship between a first faction of the first NPC and a second faction of the second NPC. In specific embodiments, the world state may comprise aggregated data derived from the alignment vector of the at least one NPC state and may represent a relationship between a faction of the corresponding NPC and a player character.

In specific embodiments, at step 910, user input indicating a player action may be received. The user input may be from, or associated with, a first user.

At step 915, an LLM may generate one or more control outputs based on probabilistic reasoning, the world state, and at least one NPC state of the plurality of NPC states. In specific embodiments, generating the one or more control outputs may be triggered by the player action (e.g., received at step 910). In specific embodiments, the LLM may be executed during a runtime execution of the game engine and may operate as a decision authority that determines modifications to the world state. In specific embodiments, the probabilistic reasoning performed by the LLM may be constrained by one or more gameplay policies enforced by the game engine.

In specific embodiments and as part of generating the one or more control outputs, at step 920, a subset of the plurality of NPC states may be selected based on relevance to a current gameplay condition. In specific embodiments and as part of generating the one or more control outputs, at step 925, the subset of the plurality of NPC states may be evaluated.

At step 930, the game engine may modify the world state based on the one or more control outputs (e.g., generated at step 915).

In specific embodiments and as part of modifying the world state, at step 935, at least one relationship parameter governing interactions between a first NPC and a second NPC may be altered.

In specific embodiments and as part of modifying the world state, at step 940, at least one relationship parameter governing interactions between a first group (e.g., faction, class) of NPCs and a second group of NPCs may be altered.

In specific embodiments and as part of modifying the world state, at step 945, at least one player objective (e.g., quest) may be generated or updated.

In specific embodiments and as part of modifying the world state, at step 950, one or more gameplay parameters that govern at least one of a reward allocation or a difficulty level may be adjusted.

In specific embodiments and as part of modifying the world state, at step 955, the alignment vector may be modified based on the one or more control outputs. In specific embodiments and as part of modifying the world state, at step 960, one or more NPC actions may be performed based on the modified alignment vector. In specific embodiments and as part of modifying the world state, at step 965, the world state may be updated based on the one or more NPC actions (e.g., performed at step 960).

In specific embodiments, at step 970, the game engine may modify the alignment vector based on the one or more control outputs (e.g., generated at step 915).

In specific embodiments, at step 975, the modified world state may be persisted for use in a subsequent gameplay execution for a second user different than the first user (whose input may have been received at step 910).

The systems and methods disclosed herein provide technical improvements to interactive computer games by enabling gameplay behavior, world dynamics, and content generation to adapt continuously based on maintained state and probabilistic reasoning rather than fixed scripts or static rules. By integrating an LLM as a runtime decision component that evaluates NPC state, world state, and player interactions, the system allows non-player characters, factions, quests, rewards, and game content to evolve coherently over time. This approach increases immersion and replayability by producing emergent behavior and shared world continuity across players, while reducing the need for extensive manual authoring and rigid behavior trees. At the same time, the invention preserves game balance and designer intent through policy constraints and structured state management, resulting in scalable, personalized, and context-aware gameplay experiences that respond meaningfully to player actions without sacrificing technical control or consistency.

The systems and methods described herein are implemented using computing systems that execute a game engine configured to maintain and update machine-readable data structures representing NPC state and world state. These data structures include persistent representations of prior interactions, alignment vectors, relationship parameters, and other state information that governs gameplay behavior. The invention operates through concrete computing operations, including storing and retrieving state information from memory, executing an LLM during runtime, generating control outputs using probabilistic reasoning, and programmatically modifying world-state data structures based on those control outputs. These operations are performed by one or more processors and cannot be performed mentally or through pen-and-paper processes. The probabilistic reasoning performed by the LLM involves execution of trained computational models that evaluate multi-dimensional state data and generate control outputs that are applied programmatically to modify world-state data structures. Such operations require computer-specific capabilities, including persistent memory management, runtime model execution, and automated state updates across gameplay sessions or game instances, and cannot be practically performed by a human without the use of computing systems.

The disclosed architecture provides a practical application of probabilistic modeling and LLMs by integrating them into the runtime control loop of a game engine. Rather than generating narrative content in isolation, the LLM evaluates maintained NPC state and world state to generate control outputs that directly modify how the game engine computes relationships, behavior, objectives, rewards, and difficulty. This results in a technical improvement to game engine operation by enabling dynamic, state-driven gameplay evolution without reliance on static scripts, fixed decision trees, or preauthored behavior logic. By modifying underlying world-state data structures rather than merely presenting information to a user, the invention improves the manner in which interactive game systems process, update, and persist gameplay state.

The described embodiments are rooted in computer technology and are limited to specific implementations involving maintained state representations, runtime execution of an LLM, and programmatic modification of gameplay data structures. The use of persistent memory, gameplay context builders, control interfaces, and cross-instance state transfer further demonstrates that the invention is directed to a specific technological solution for managing adaptive and persistent gameplay behavior in computer systems.

At least one processor in accordance with this disclosure can include at least one non-transitory computer readable media. The at least one processor could comprise at least one computational node in a network of computational nodes. The media could include cache memories on the processor. The media can also include shared memories that are not associated with a unique computational node. The media could be a shared memory, could be a shared random-access memory, and could be, for example, a DDR DRAM. The shared memory can be accessed by multiple channels. The non-transitory computer readable media can store data required for the execution of any of the methods disclosed herein, the instruction data disclosed herein, and/or the operand data disclosed herein. The computer-readable media can also store instructions which, when executed by the system, cause the system to execute the methods disclosed herein. The concept of executing instructions is used herein to describe the operation of a device conducting any logic or data movement operation, even if the “instructions” are specified entirely in hardware (e.g., an AND gate executes an “and” instruction). The term is not meant to impute the ability to be programmable to a device.

In specific embodiments, one or more of the machine intelligence components described herein may be implemented as standalone content-generation systems separate from the runtime game engine. For example, a large language model or other probabilistic decision model that receives a structured prompt (e.g., full item prompt 830, world lore prompt 860, or other structured gameplay context data) may operate as an independent service configured to generate machine-readable gameplay content. Such generated content may include item definitions, NPC backstories, faction histories, quest structures, dialogue trees, behavioral parameter sets, alignment-vector initializations, event templates, or other structured data. The generated outputs may be written to one or more persistent databases, asset repositories, or content stores, and may subsequently be retrieved and utilized by a game engine during gameplay execution.

In these embodiments, the game engine that consumes the generated content need not itself implement the runtime world-orchestration architecture described elsewhere in this disclosure. Instead, a more traditional or static game engine—such as one relying on deterministic state machines, predefined branching logic, or fixed rule systems—may load and execute content that was generated or curated by the standalone machine intelligence system. The standalone component may operate during development time, deployment time, scheduled batch execution, or asynchronous runtime execution, and may update or expand game databases without requiring direct integration into the core control loop of the game engine. In this manner, the disclosed machine intelligence techniques may be used to populate, refine, or evolve gameplay databases independently of the runtime decision architecture.

In further embodiments, the standalone machine intelligence component may be deployed as a remote service, distributed system, or cloud-based generation module accessible by multiple different game engines or titles. Generated content may be versioned, validated, filtered, or post-processed prior to integration into gameplay systems. The separation between content generation and runtime execution allows hybrid architectures in which some gameplay elements are governed by traditional engine logic while others are influenced by generated or periodically updated machine-intelligence-derived data. Accordingly, the invention encompasses both tightly integrated runtime orchestration systems and modular content-generation systems that produce machine-readable gameplay artifacts for use by independent or conventional game engines.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. Although examples in the disclosure were generally directed to interactive computer games and gameplay scenarios involving non-player characters, the systems and methods described herein may be applied to other interactive or simulated environments in which autonomous entities, persistent state, and probabilistic decision-making are used to control behavior and system-level interactions. Furthermore, while many examples herein describe generation of control outputs using an LLM, the invention is not limited to any particular model architecture. The described probabilistic reasoning and control-output generation may be performed by any machine intelligence system capable of evaluating maintained state data and generating machine-readable control outputs, including but not limited to transformer-based models, recurrent neural networks, diffusion-based models, reinforcement learning agents, probabilistic graphical models, hybrid symbolic-neural systems, evolutionary computation systems, mixture-of-experts models, or other learned or adaptive computational architectures. In some embodiments, the control outputs may be generated by a reasoning model, a multimodal model, a world model, a planning model, an agent-based architecture, or a distributed ensemble of models operating cooperatively. In other embodiments, the control outputs may be generated by future-developed computational intelligence systems that perform state evaluation and probabilistic or learned decision-making, whether or not such systems are characterized as “language models.” Accordingly, references herein to a “large language model” are intended to describe one example implementation of a probabilistic decision component and should not be construed as limiting. Any computational model capable of evaluating maintained NPC state, world state, player interaction data, or other machine-readable gameplay state and generating control outputs for modifying world-state data structures falls within the scope of the present disclosure. These and other modifications and variations to the present invention may be practiced by those skilled in the art, without departing from the scope of the present invention, which is more particularly set forth in the appended claims.

What is claimed is:

1. A computer-implemented method for controlling gameplay in an interactive computer
game, the method comprising:
maintaining, by a computing system executing a game engine, a plurality of non-player character (NPC) states for a plurality of NPCs and a world state, wherein each NPC state of the plurality of NPC states: (i) corresponds to an NPC of the plurality of NPCs, (ii) includes data representative of prior in-game interactions with the corresponding NPC, and (iii) includes an alignment vector of the corresponding NPC, and wherein the world state governs relationships among the plurality of NPCs based at least in part on the alignment vectors of the plurality of NPCs;
generating, by a large language model, one or more control outputs based on probabilistic reasoning, the world state, and at least one NPC state of the plurality of NPC states; and
modifying, by the game engine, the world state based on the one or more control outputs.

2. The computer-implemented method of claim 1, wherein:
the alignment vector comprises a plurality of machine-readable values encoding tendencies or affiliations of the corresponding NPC relative to at least one other NPC, faction, or player character; and
the alignment vector is stored in a neural memory structure.

3. The computer-implemented method of claim 1, further comprising modifying, by the game engine, the alignment vector based on the one or more control outputs.

4. The computer-implemented method of claim 1, wherein the world state comprises aggregated data derived from alignment vectors of a first NPC and a second NPC of the plurality of NPCs and represents a relationship between a first faction of the first NPC and a second faction of the second NPC.

5. The computer-implemented method of claim 1, wherein the world state comprises aggregated data derived from the alignment vector of the at least one NPC state and represents a relationship between a faction of the corresponding NPC and a player character.

6. The computer-implemented method of claim 1, wherein modifying the world state comprises:
modifying the alignment vector based on the one or more control outputs;
performing one or more NPC actions based on the modified alignment vector; and
updating the world state based on the one or more NPC actions.

7. The computer-implemented method of claim 1, further comprising:
receiving user input indicating a player action;
wherein generating the one or more control outputs is triggered by the player action.

8. The computer-implemented method of claim 7, wherein the user input is from a first user,
and further comprising:
persisting the modified world state for use in a subsequent gameplay execution for a second user different than the first user.

9. The computer-implemented method of claim 1, wherein generating the one or more
control outputs comprises:
selecting a subset of the plurality of NPC states based on relevance to a current gameplay condition; and
evaluating the subset of the plurality of NPC states.

10. The computer-implemented method of claim 1, wherein the large language model is executed during a runtime execution of the game engine and operates as a decision authority that determines modifications to the world state.

11. The computer-implemented method of claim 1, wherein modifying the world state comprises altering at least one relationship parameter governing interactions between a first NPC and a second NPC of the plurality of NPCs.

12. The computer-implemented method of claim 1, wherein modifying the world state comprises altering at least one relationship parameter governing interactions between a first group of NPCs of the plurality of NPCs and a second group of NPCs of the plurality of NPCs.

13. The computer-implemented method of claim 1, wherein the probabilistic reasoning performed by the large language model is constrained by one or more gameplay policies enforced by the game engine.

14. The computer-implemented method of claim 1, wherein modifying the world state comprises generating or updating at least one player objective.

15. The computer-implemented method of claim 1, wherein modifying the world state comprises adjusting one or more gameplay parameters that govern at least one of a reward allocation or a difficulty level.

16. A system for controlling gameplay in an interactive computer game, comprising:
a computing system including one or more processors and memory;
a game engine executed by the one or more processors and configured to maintain a plurality of non-player character (NPC) states for a plurality of NPCs, and a world state, wherein each NPC state of the plurality of NPC states: (i) corresponds to an NPC of the plurality of NPCs, (ii) includes data representative of prior in-game interactions with the corresponding NPC, and (iii) includes an alignment vector of the corresponding NPC, and wherein the world state governs relationships among the plurality of NPCs based at least in part on the alignment vectors of the plurality of NPCs; and
a large language model executed by the one or more processors and configured to generate one or more control outputs based on probabilistic reasoning, the world state, and at least one NPC state of the plurality of NPC states;
wherein the game engine is further configured to modify the world state based on the one or more control outputs generated by the large language model.

17. The system of claim 16, wherein:
the alignment vector comprises a plurality of machine-readable values encoding tendencies or affiliations of the corresponding NPC relative to at least one other NPC, faction, or player character; and
the alignment vector stored in a neural memory structure.

18. The system of claim 16, wherein the game engine is further configured to modify the alignment vector based on the one or more control outputs.

19. The system of claim 16, wherein the world state comprises aggregated data derived from alignment vectors of a first NPC and a second NPC of the plurality of NPCs and represents a relationship between a first faction of the first NPC and a second faction of the second NPC.

20. A non-transitory computer-readable medium storing instructions that, when executed by
one or more processors, cause the one or more processors to perform operations for controlling gameplay in an interactive computer game, the operations comprising:
maintaining, by a computing system executing a game engine, a plurality of non-player character (NPC) states for a plurality of NPCs and a world state, wherein each NPC state of the plurality of NPC states: (i) corresponds to an NPC of the plurality of NPCs, (ii) includes data representative of prior in-game interactions with the corresponding NPC, and (iii) includes an alignment vector of the corresponding NPC, and wherein the world state governs relationships among the plurality of NPCs based at least in part on the alignment vectors of the plurality of NPCs;
generating, by a large language model, one or more control outputs based on probabilistic reasoning, the world state, and at least one NPC state of the plurality of NPC states; and
modifying, by the game engine, the world state based on the one or more control outputs.
